(19) United States
(12) Patent Application Publication
(10) Pub. No.: US 2014/0149079 A1
(43) Pub. Date: May 29, 2014

(54) RFID SENSOR TAG SUPPORTING DUAL MODE LOGGING, RFID SENSOR READER AND CONTROLLING METHOD THEREOF

(71) Applicants: KOREA FOOD RESEARCH INSTITUTE, Gyeonggi-do (KR); Electronics and Telecommunications Research Institute, Daejeon-si (KR)

(72) Inventors: Dong-Beom SHIN, Daejeon-si (KR); Sang-Yeoun LEE, Daejeon-si (KR); Hyun-Seok KIM, Jeollabuk-do (KR); Chan-Won PARK, Daejeon-si (KR); Jong-Hoon KIM, Seoul (KR); Byeong-Sam KIM, Gyeonggi-do (KR)

(73) Assignees: KOREA FOOD RESEARCH INSTITUTE, Gyeonggi-do (KR); Electronics and Telecommunications Research Institute, Daejeon-si (KR)

(21) Appl. No.: 14/057,742

(22) Filed: Oct. 18, 2013

(30) Foreign Application Priority Data
Nov. 27, 2012 (KR) 10-2012-0135474

(51) Int. Cl. G01D 9/00

(52) U.S. Cl. CPC G01D 9/00
USPC 702/187

(57) ABSTRACT

Disclosed is an RFID sensor tag supporting dual mode logging, an RFID sensor reader, and a controlling method thereof. The RFID sensor tag includes a controller that supports a dual mode including a scheduling logging mode in which sensor data is recorded in a predetermined interval and an alarm event logging mode in which sensor data is recorded in a predetermined alarm condition and records sensor data in the memory when a corresponding mode is performed and a memory that has a sensor data recording area divided per mode.

### CROSS-REFERENCE TO RELATED APPLICATION

This application claims the benefit under 35 U.S.C. §119(a) of Korean Patent Application No. 10-2012-0135474, filed on Nov. 27, 2012, the entire disclosure of which is incorporated herein by reference for all purposes.

### BACKGROUND

1. Field

The following description relates to an RFID technology, and more particularly, to a RFID-based data sensing and recognizing technology.

2. Description of the Related Art

An RFID sensor tag is a tag configured by adding a sensor that can acquire external environment information and a battery for its own electric power supply to an RFID tag that can acquire an IDentification (ID) that enables a tag to be identified, and operates in a semi-passive scheme. The RFID sensor tag manages temperature information of an article to which the tag is attached and also supports a sensor data logging function for a real-time management and post-processing on environment information to be controlled by an industry. Further, environment information management processes have been optimized to manage qualities of articles so that the loss cost at the business side and the social loss cost of the people due to spoiled articles can be minimized.

Recently, a lot of foreign agricultural and animal products have been imported and distributed, and some of them may include ingredients harmful to the human body. Accordingly, demands of customers on the safe food have been increased. In addition, the industries of semiconductors, medicine and medical supplies, groceries, which importantly need constant temperature and humidity management, require technologies that can prevent loss at the company side and minimize social loss cost of consumers caused by spoiled products by optimizing processes of managing environment information on products and managing qualities of the products. In this regard, technologies have been developed that use barcodes, RFID, and the like, to recognize information on products and manage comprehensive history from production through distribution to consumption. Recently, a service of applying an RFID sensor tag providing environment history of products by sensing the environment around the products has been introduced.

The RFID sensor tag is attached to products such as foods that can be spoiled in a distribution stage or medicine and medical supplies including blood that need careful is managements and provides environment history of the products by monitoring environments around the products at a distribution stage from the production to consumption of the products. Middle managers and end consumers may obtain environment information provided during delivery of the products through the RFID sensor tags attached to the products to check the safety of the corresponding products. The RFID sensor tag senses environment information around the products and records the environment information in its own memory. At this point, the sensed environment information has a value as information only when the information is provided with time information. Therefore, in order to simultaneously record sensor information and time information in a limited memory of the RFID sensor tag, an effective method of using the memory is required.

### SUMMARY

According to an aspect of the present invention, a technology of effectively configuring a memory of an RFID sensor tag and promptly reading data from the RFID sensor tag by an RFID sensor reader has been proposed.

In one general aspect, an RFID sensor tag includes a controller that supports a dual mode including a scheduling logging mode in which sensor data is recorded according to a predetermined interval and an alarm event logging mode in which sensor data is recorded according to a predetermined alarm condition and records sensor data in the memory when a corresponding mode is performed and a memory configured to have a sensor data recording area divided per mode.

A starting address of the memory in which data is recorded when the scheduling logging mode is performed and a starting address of the memory in which data is recorded when the alarm event logging mode is performed may be different from each other.

The sensor data recording area of the memory may include a scheduling logging area in which data is recorded in the scheduling logging mode, an alarm event logging area in which data is recorded in the alarm event logging mode, and a common recording area in which data is commonly recorded regardless of kinds of the modes.

The controller records sensor data except time information in the scheduling logging area of the memory and records time information together with sensor data in the alarm event logging area in the memory.

The controller first records sensor data in each of the logging area per logging mode and then records sensor data in the common recording area when each of the logging area is filled.

When recording sensor data in the common recording area, if sensing events with respect to the logging modes simultaneously occur, the controller may preferentially record sensor data in a logging mode of a higher priority.

If a size of the common recording area is smaller than a size of the sensor data with respect to a currently performed logging mode, the controller may stop the corresponding logging mode.

In another general aspect, an RFID sensor reader includes a data reading unit that reads setting information, state information, and sensor data recorded in a corresponding mode from a memory of an RFID sensor tag in which storage areas are divided by a scheduling logging mode and an alarm event logging mode.

The data reading unit may read sensor data recorded in an alarm event logging mode from a scheduling logging area of the memory together with time information, read sensor data recorded in the scheduling logging mode from an alarm event logging area of the memory, and read state information of the memory and setting information and state information from an operation mode setting area.

The RFID sensor reader may further include a data analyzing unit that analyzes the setting information and the state information read from the data reading unit to calculate the number of sensor data recorded in the scheduling logging mode and time information when each sensor data is sensed, and maps the calculated time information with the sensor data in the scheduling logging mode read from the data reading unit to acquire sensor data with time information in the scheduling logging mode.

In another general aspect, in an RFID sensor tag controlling method, an RFID sensor tag sets a sensor data starting position and a size of a memory in a scheduling logging mode of the RFID sensor tag and a sensor data starting position and a size of a memory in an alarm event logging mode, and records data in designated areas of the memory according to a method set in the setting of the sensor data starting positions and the sizes.

In the recording of the data, the RFID sensor tag may record data in a scheduling logging area of the memory when the scheduling logging mode is performed and may record data in an alarm event logging area when the alarm event logging mode is performed.

In the recording of the data, the RFID sensor tag may record sensor data except time information in the scheduling logging area of the memory and record time information together with sensor data in the alarm event logging area of the memory.

In the recording of the data, the RFID sensor tag may record sensor data in a common recording area of the memory, if memory areas designated in the logging modes are filled. At this point, when recording sensor data in the common recording area, if events with respect to the logging modes occur simultaneously, the RFID sensor tag may preferentially record sensor data of a logging mode of a higher priority.

In the setting of the sensor data starting positions and the sizes, after the logging areas designated in the logging modes are filled, if events with respect to the logging modes occur simultaneously, the RFID sensor tag may also set logging mode priorities to preferentially record data in the common recording area of the memory.

The RFID sensor tag is attached to products such as foods that can be spoiled in a distribution stage or medicine and medical supplies including blood that need careful managements and provides environment history of the products by monitoring environments around the products at a distribution stage from the production to consumption of the products. The RFID sensor tag may record data largely in two logging modes including a scheduling logging mode and an alarm event logging mode. However, in a dual mode in which the two logging modes can be performed, storage areas of the memory are wasted and consequently the memory of the RFID sensor tag requires a high capacity so as to increase the cost of the RFID sensor tag. Further, it takes a lot of time to be read the high capacity memory of the RFID sensor tag by the RFID sensor reader.

According to the present invention, the problems described above can be solved, and limited memory areas can be effectively used by separately dividing and managing the memory areas in which data are recorded in a scheduling logging mode and an alarm event logging mode.

Further, according to the present invention, starting addresses in the memory in which the data are recorded in a scheduling logging mode and an alarm event logging mode are differently set and only sensor data are recorded without recording time data in the scheduling logging mode, so the time data is not recorded in the scheduling logging mode. Therefore, more sensor data can be recorded in limited storage areas. Further, the RFID sensor reader does not need to waste time in reading time data.

### BRIEF DESCRIPTION OF THE DRAWINGS

FIG. 1 is a reference diagram illustrating a tag memory map to which the present invention is applied.

FIG. 2 is a reference diagram illustrating a message structure of a read command defined by the RFID standard in order to raise a necessity on an efficient storage of an RFID sensor tag memory according to an embodiment of the present invention.

FIG. 3 is a diagram illustrating a configuration of an RFID system in which a memory is effectively configured according to an embodiment of the present invention.

FIG. 4 is a diagram illustrating detailed configurations of an RFID sensor tag and an RFID sensor reader according to an embodiment of the present invention.

FIG. 5 is a diagram illustrating a detailed structure of a memory of the RFID sensor tag in FIG. 4.

FIG. 6 is a flowchart illustrating a control method of an RFID sensor tag that supports dual mode logging according to an embodiment of the present invention.

### DETAILED DESCRIPTION

Hereinafter, various embodiments of the present invention will be described with reference to the accompanying drawings. Further, in the following description of the present invention, a detailed description of known functions and configurations incorporated herein will be omitted when it may make the subject matter of the present invention rather unclear. Also, the terms described below are defined in consideration of the functions of the present invention, and may differ in accordance with a user's or operator's intention or custom, and the definition of such wordings should be made based on the contents throughout the entire description of the present invention.

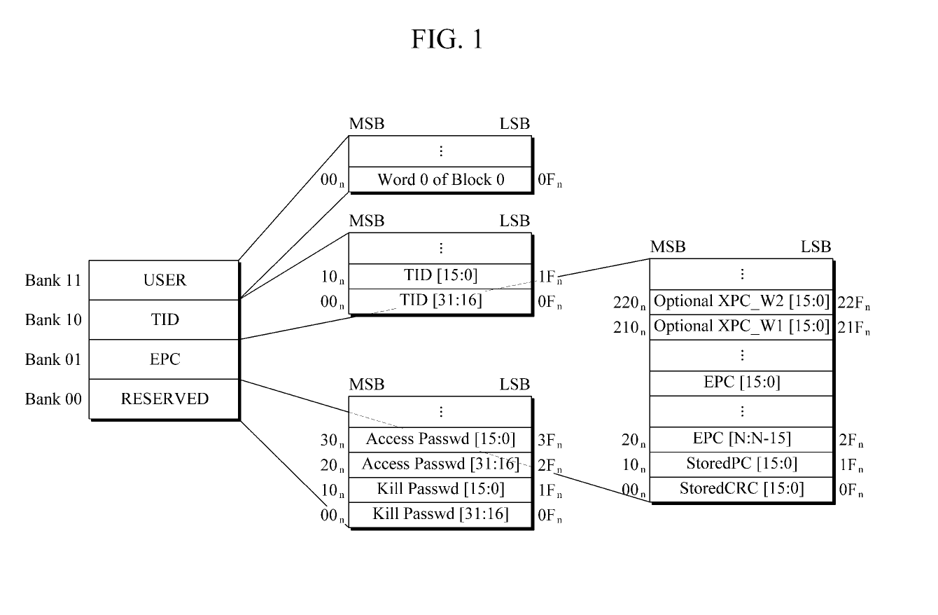

FIG. 1 is a reference diagram illustrating a tag memory map to which the present invention is applied.

Specifically, FIG. 1 is a tag memory map defined by ISO/IEC 18000-6 which is an international organization for standardization of an ultra-high frequency (UHF) band and EPCglobal Class-1 Generation 2 which is a commercial standard organization of an RFID tag. An UHF RFID tag memory is logically divided into four areas. As illustrated in FIG. 1, a Bank0 (Reserved memory) area includes a Kill pass word and an Access password. PC, XPC, EPC, and the like are recorded in a Bank1 (Electronic Product Code: EPC) area. A Bank2 (TID) area includes a class-identifier, a tag serial number or the like defined in ISO/IEC 15963. A Bank3 (User Memory) area is a user memory area and includes data defined by a user, and the RFID sensor tag generally includes sensor-related information and sensor data.

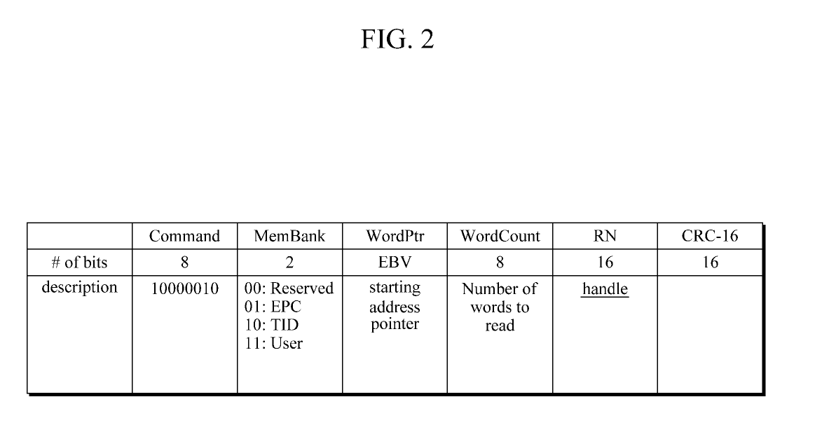

FIG. 2 is a reference diagram illustrating a message structure of a read command defined by the RFID standard in order to raise a necessity on an efficient storage of an RFID sensor tag memory according to an embodiment of the present invention.

With reference to FIG. 2, the Read command starts with 0xA2, and designates a memory bank and a starting address of an RFID sensor tag. The read command can read only up to 255 words (1 Word=16 bit), that is, 4,080 bits (510 Bytes) with one access and if the quantity of data is 4,080 bits or more, read commands should be continuously transmitted. In this manner, since the read command defined by the RFID standard has the limited quantity of data that can be read once, a method of effectively storing sensor data in a memory of the RFID sensor tag.

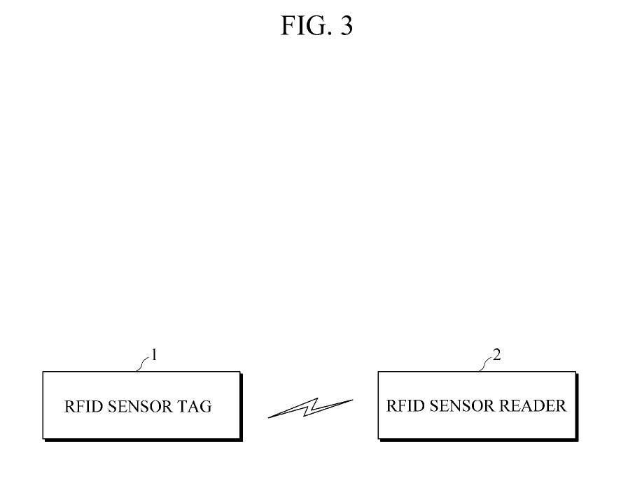

FIG. 3 is a diagram illustrating a configuration of an RFID system in which a memory is effectively configured according to an embodiment of the present invention.

With reference to FIG. 3, the RFID system includes an RFID sensor tag 1 and an RFID sensor reader 2.

The RFID sensor tag 1 is a tag configured by adding a sensor that senses external environment information to a conventional RFID tag that can acquire an IDentification (ID) that enables a tag to be identified, and the RFID sensor tag 1 can further include a battery for its own electric power supply.

The RFID sensor tag 1 may enter a scheduling logging mode or an alarm event logging mode to record sensor data in the memory, or enter a dual mode in which the scheduling logging mode and the alarm event logging mode are performed at the same time to record sensor data in the memory. The scheduling logging mode is a mode in which the sensor data are recorded in the memory at a predetermined interval. The alarm event logging mode is a mode in which the sensor data are recorded in the memory according to a predetermined alarm condition.

The time at which the sensor data are sensed by the sensor in the RFID sensor tag has an important function, so the sensor time is generally recorded together when recording the sensor data. According to a general RFID sensor tag memory operating method, if the RFID sensor tag supports the scheduling logging mode and the alarm event logging mode at the same time, the time data and the sensor data are recorded sequentially from a specific address in the memory of the RFID sensor tag. However, this sequential recording method occupies a greatly large memory space of the RFID sensor tag, and consumes a lot of time in reading all the data by the RFID sensor reader.

Accordingly, the present invention suggests a method of effectively storing the sensor data in the memory by the RFID sensor tag 1 in the dual mode. Specifically, the RFID sensor tag 1 manages the memory areas in which data are recorded in the scheduling logging mode and the alarm event logging mode, in a separated manner. At this point, the data are not sequentially recorded in the memory of the RFID sensor tag 1 from a specific address, but the data are recorded so that starting addresses of the memory in which the data are recorded in the scheduling logging mode and the alarm event logging mode are differently set. Further, the time data and the sensor data are not recorded in the memory of the RFID sensor tag 1 at the same time, but only the sensor data are recorded in the scheduling logging mode without recording the time data. Accordingly, the storage area of the memory can be effectively used than the time data and the sensor data are recorded at the same time.

The RFID sensor reader 2 reads data record in the RFID sensor tag 1, and acquires scheduling logging mode starting time and scheduling interval information by reading scheduling logging mode setting information. Further, the RFID sensor reader 2 calculates sensor time of the sensor data record in the scheduling logging mode by using the acquired information. According to this, since it is not necessary to record the time data in the scheduling logging mode together in a separated manner, when recording the sensor data, more sensor data can be record in the same memory area so that the memory storage area can be used more effectively and the RFID sensor reader 2 does not need to spend time to read unnecessary time data.

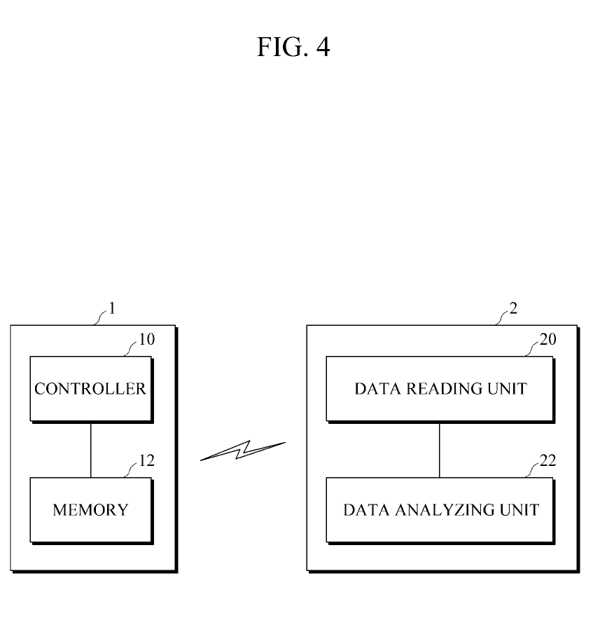

FIG. 4 is a diagram illustrating detailed configurations of an RFID sensor tag 1 and an RFID sensor reader 2 according to an embodiment of the present invention.

With reference to FIG. 4, the RFID sensor tag 1 includes a controller 10 and a memory 12.

The controller 10 supports a dual mode in which a scheduling logging mode and an alarm event logging mode are performed, and records sensor data in the memory 12 when performing the corresponding mode. The memory 12 has a sensor data recording area divided per mode.

According to an embodiment, the starting address of the memory 12 in which data are recorded when the scheduling logging mode is performed and the starting address of the memory 12 when the alarm event logging mode is performed are different from each other.

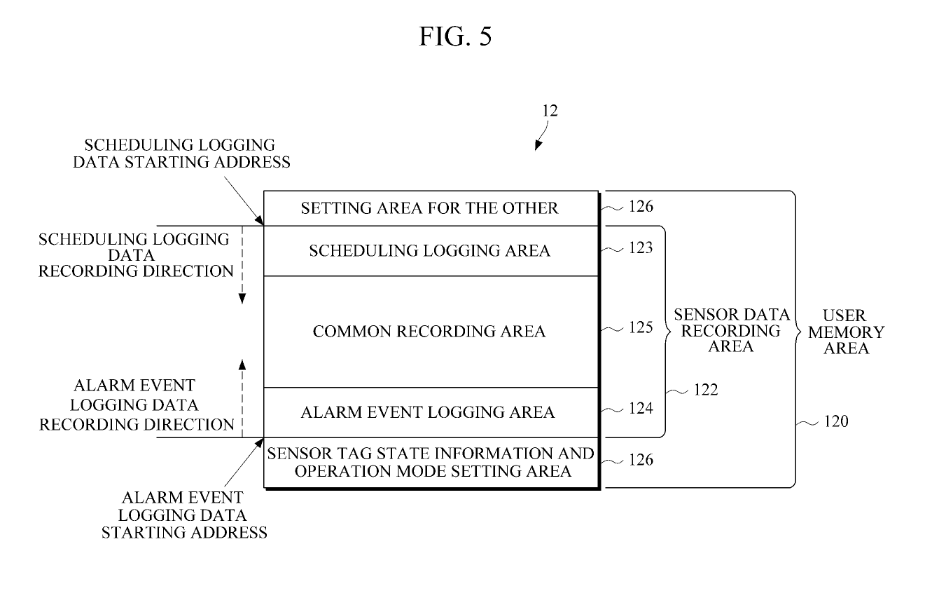

The sensor data recording area of the memory 12 includes a scheduling logging area in which data are recorded when the scheduling logging mode is performed, an alarm event logging area in which the data are recorded when the alarm event logging mode is performed, and a common recording area in which data are recorded regardless of kinds of modes. The storage area of the memory 12 will be described in detail with reference to FIG. 5.

According to an embodiment, the controller 10 records sensor data except time information in the scheduling logging area of the memory 12, and records time information together with the sensor data in the alarm event logging area.

According to an embodiment, the controller 10 records sensor data in each logging area per logging mode first, and records sensor data in the common recording area after all the logging areas are filled.

When recording sensor data in the common recording area, if the event with respect to each logging mode is generated at the same time, the controller 10 may preferentially record sensor data in the logging mode which has a higher priority. For example, if the scheduling logging mode has a higher priority than the alarm event logging mode, data on the event generated in the scheduling logging mode may be recorded in the common recording area, before recording data on the event generated in the alarm event logging mode.

According to an embodiment, when the size of the common recording area is smaller than the size of the sensor data in the currently performed logging mode, the controller 10 stops the corresponding logging mode.

Meanwhile, the RFID sensor reader 2 includes a data reading unit 20 and a data analyzing unit 22.

The data reading unit 20 reads setting information, state information, and sensor data recorded in the corresponding mode from the memory 12 of the RFID sensor tag 1 in which storage areas are divided by the scheduling logging mode and the alarm event logging mode. At this point, the data reading unit 20 may read sensor data recorded in the alarm event logging mode from the scheduling logging area of the memory 12 together with time information, read sensor data recorded in the scheduling logging mode from the alarm event logging area of the memory 12, and read setting information and state information from the state information and operation mode setting area of the memory 12.

The data analyzing unit 22 analyzes state information and setting information read from the data reading unit 20 and calculates the number of the sensor data recorded in the scheduling logging mode and time information when each of the sensor data is sensed. Further, the data analyzing unit 22 maps the calculated time information with the sensor data in the scheduling logging mode which is read from the data reading unit 20 to acquire sensor data having time information in the scheduling logging mode.

FIG. 5 is a diagram illustrating a detailed structure of the memory 12 of the RFID sensor tag 1 in FIG. 4.

With reference to FIG. 5, a user memory area 120 of the memory 12 is broadly divided into a sensor data recording area 122 and a sensor tag state information and operation mode setting area 126 to process sensor-related information. The sensor data recording area 122 may be divided into a scheduling logging area 123 and an alarm event logging area 124, and further include a common recording area 125 and a setting area 126 for the other.

The sensor tag state information and operation mode setting area 126 includes sensor-related state information such as starting points of the sensor data, a memory range, a sensor type, a sensor data accuracy, a data type, and a measurement range, and RFID sensor tag operation mode setting information such as upper and lower alarm ranges, sensing starting time, and sampling intervals. Further, the sensor tag state information and operation mode setting area 126 includes memory positions and memory sizes to start recording the sensor data in the scheduling logging mode and memory positions and memory size information to start recording the sensor data in the alarm event logging mode.

When recording data in the scheduling logging mode, sensor data can be recorded except time information in the scheduling logging area 123. When data are recorded in the alarm event logging mode, time information can be recorded together with the sensor data in the alarm event logging area 124. The data including the sensor data and the time information together is referred to as time-stamped data.

Data is recorded in the common recording area 125 regardless of the kinds of the modes. According to an embodiment, the sensor data are first recorded in each of the logging areas 123 and 124 per logging mode, and then the sensor data are recorded in the common recording area 125 after both of the logging areas 123 and 124 are filled.

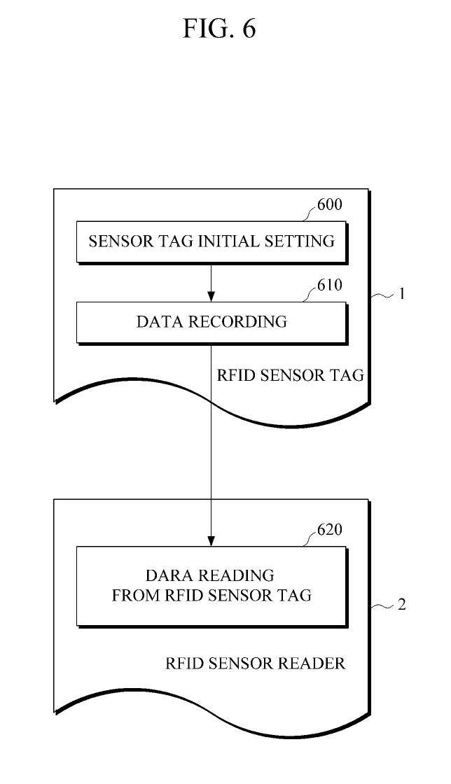

FIG. 6 is a flowchart illustrating a control method of an RFID sensor tag that supports dual mode logging according to an embodiment of the present invention.

With reference to FIG. 6, initial setting with respect to each logging mode is performed in order to store the data in divided memory areas of the RFID sensor tag 1 for each of the scheduling logging mode and the alarm event logging mode in operation 600.

The RFID sensor tag initial setting operation 600 will be described in detail. First, the operation mode of the RFID sensor tag 1 is set. In the operation mode setting, operations such as Real Time Clock setting, sensor setting to be used in the case of multiple sensors, High/Low alarm condition setting, sensor data logging condition setting, sensor data configuration setting (Sensor Data Only/Time-Stamped Data), scheduling monitoring interval setting, alarm event monitoring interval setting, sensor data starting point setting, and logging starting time setting are performed.

Further, in the RFID sensor tag initial setting operation 600, a starting position and a size of a memory in which the sensor data are recorded in the scheduling logging mode, and a starting position and a size of a memory in which the sensor data are recorded in the alarm event logging mode are set. In addition, when recording data in the common recording area of the memory, since two logging mode events may simultaneously occur, a priority of the logging modes may be set.

When the RFID sensor tag initial setting operation 600 has been completed, the RFID sensor tag 1 is attached to an article. The RFID sensor tag 1 attached to the article senses environment information of the article in every operation in all distribution stages (production, transportation, storage, and the like) and records the sensed data in the memory in operation 610.

In the data recording operation 610, the RFID sensor tag 1 respectively records sensor data to designated areas in the memory according to each logging condition based on predetermined logging conditions. Subsequently, if the memory areas designated in each mode are all filled, the sensor data are recorded in the common recording area. The common recording area can be preoccupied by a logging mode in which an event occurs first, and when the two logging conditions (scheduling logging and alarm event logging) records data in the common area, if data record events occur at the same time, data in the logging mode of the higher priority can be recorded first. The priority may be determined in the initial setting operation 600 of the RFID sensor tag 1.

Subsequently, sensor data recorded in the RFID sensor tag are read and examined using the RFID sensor reader 2 in the middle or final stage of the distribution in operation 620. The RFID sensor reader 2 uses a read command to read the sensor data in a block unit.

According to an embodiment, the RFID sensor reader 2 analyzes the state information and setting information read from the RFID sensor tag 1 to calculate the number of sensor data recorded in the scheduling logging mode and time information when each of the sensor data is sensed. Further, the RFID sensor reader 2 maps the calculated time information with the sensor data which is read from the RFID sensor tag 1 in the scheduling logging mode to acquire the sensor data (Time-Stamped Sensor data) having the time information in the scheduling logging mode.

When the RFID sensor tag 1 performs data logging in the alarm event logging mode, since the sensor data (Time-Stamped Sensor data) in the complete form are recorded in the memory, the RFID sensor reader 2 only reads the sensor data and uses it without processing.

The exemplary embodiments of the present invention have been described as above. It will be understood by those of ordinary skill in the art that various modifications may be made therein without departing from the original characteristics of the present invention. Therefore, the invention should not be construed as limited to the embodiments set forth herein. The scope of the present invention is as recited in the accompanying claims, not as described in the detailed description above, and differences in the same scope as the present invention should be construed to be included in the present invention.

What is claimed is:

1. An RFID sensor tag, comprising:
a controller configured to support a dual mode in which a scheduling logging mode of recording sensor data according to a predetermined interval and an alarm event logging mode of recording sensor data according to a predetermined alarm condition are performed and record sensor data in the memory when a corresponding mode is performed; and
a memory having a sensor data recording area divided per mode.

2. The RFID sensor tag of claim 1, wherein a starting address of the memory in which data is recorded when the scheduling logging mode is performed and a starting address of the memory in which data is recorded when the alarm event logging mode is performed are different from each other.

3. The RFID sensor tag of claim 1, wherein the sensor data recording area of the memory includes a scheduling logging area in which data is recorded in the scheduling logging mode, an alarm event logging area in which data is recorded in the alarm event logging mode, and a common recording area in which data is commonly recorded regardless of kinds of the modes.

4. The RFID sensor tag of claim 3, wherein the controller records sensor data except time information in the scheduling logging area of the memory and records time information together with sensor data in the alarm event logging area in the memory.

5. The RFID sensor tag of claim 3, wherein the controller first records sensor data in each of the logging area per logging mode and then records sensor data in the common recording area when each of the logging area is filled.

6. The RFID sensor tag of claim 5, wherein when recording the sensor data in the common recording area, if sensing events with respect to the logging modes simultaneously occur, the controller preferentially records sensor data in a logging mode of a higher priority.

7. The RFID sensor tag of claim 3, wherein if a size of the common recording area is smaller than a size of the sensor data with respect to a currently performed logging mode, the controller stops the corresponding logging mode.

8. An RFID sensor reader, comprising:
a data reading unit configured to read setting information, state information, and sensor data recorded in a corresponding mode from a memory of an RFID sensor tag in which storage areas are divided by a scheduling logging mode and an alarm event logging mode.

9. The RFID sensor reader of claim 8, wherein the data reading unit reads sensor data recorded in an alarm event logging mode from a scheduling logging area of the memory together with time information, reads sensor data recorded in the scheduling logging mode from an alarm event logging area of the memory, and reads state information of the memory and setting information and state information from an operation mode setting area.

10. The RFID sensor reader of claim 8, further comprising:
a data analyzing unit configured to analyze the setting information and the state information read from the data reading unit to calculate the number of sensor data recorded in the scheduling logging mode and time information when each sensor data is sensed, and map the calculated time information with the sensor data in the scheduling logging mode read from the data reading unit to acquire sensor data with time information in the scheduling logging mode.

11. An RFID sensor tag controlling method, comprising:
setting a sensor data starting position and a size of a memory in a scheduling logging mode of an RFID sensor tag and a sensor data starting position and a size of a memory in an alarm event logging mode; and
recording data in designated areas of the memory according to a method set in the setting of the sensor data starting positions and the sizes.

12. The RFID sensor tag controlling method of claim 11, wherein the recording of the data includes recording data in a scheduling logging area of the memory when the scheduling logging mode is performed and recording data in an alarm event logging area when the alarm event logging mode is performed.

13. The RFID sensor tag controlling method of claim 12, wherein the recording of the data includes recording sensor data except time information in the scheduling logging area of the memory and recording time information together with sensor data in the alarm event logging area of the memory.

14. The RFID sensor tag controlling method of claim 11, wherein the recording of the data includes recording sensor data in a common recording area of the memory, if memory areas designated in the logging modes are filled.

15. The RFID sensor tag controlling method of claim 14, wherein when recording sensor data in the common recording area, if events with respect to the logging modes occur simultaneously, the recording of the data includes preferentially recording sensor data of a logging mode of a higher priority.

16. The RFID sensor tag controlling method of claim 11, further comprising:
if events with respect to the logging modes occur simultaneously after the logging areas designated in the logging modes in the setting of the sensor data starting positions and the sizes are filled, setting logging mode priorities to preferentially record data in the common recording area of the memory.
